(19) United States
(12) Patent Application Publication
(10) Pub. No.: US 2004/0209639 A1
(43) Pub. Date: Oct. 21, 2004

(54) Method for establishing a connection and short-range radio transceivers unit

(76) Inventors: Erich Kamperschroer, Hamminkeln (DE); Ernst-Wilhelm Scheidemann, Rhede (DE); Uwe Schwark, Bocholt (DE)

Correspondence Address: Michael S Leonard, Bell Boyd & Lloyd, PO Box 1135, Chicago, IL, 60690, US

(21) Appl. No.: 10/488,136

(22) PCT Filed: Aug. 16, 2002
(86) PCT No.: PCT/DE02/03014

(30) Foreign Application Priority Data
Aug. 30, 2001 (DE) 101 42 496.5

(51) Int. Cl. H04B 7/00; H04Q 7/20

(52) U.S. Cl. 455/522; 455/41.2

(57) ABSTRACT

The invention relates to a method for establishing a connection and short-range radio transceiver unit for carrying out said method, whereby an inialisation of a first transmission power value (E2) occurs and a search for a second short-range transceiver unit in a radio coverage area (E3, F4) as determined by the first transmission power value. On finding a second short-range radio transceiver unit, storage of the characteristic information of the second short-range radio transceiver unit along with the first transmission power value is carried out (E4, E5). A comparison of the first transmission power value with a second transmission power value is then carried out (E6), whereby if equality is found the search is ended and where inequality is found the search is repeated with a modified first transmission power value (E8, E3, E4).

### DESCRIPTION

The invention relates to a method for establishing a connection in accordance with the preamble of claim 1 and to a short-range transceiver unit in accordance with the preamble of claim 10.

It is known that short-range transceivers are used in radio telecommunications systems and that these differ in the transmission power set for a radio communication.

Such short-range transceiver units are subdivided into classes. for example short-range transceivers designed in accordance with the “Bluetooth” short-range standard (BT device) are classified as regards their transmission power into 3 power classes.

Devices of different power levels can readily enter into a communications connection. To do this a BT device investigates its environment before establishing a communications connection, i.e. the radio coverage area (transmit area) which will be supplied by the prespecified transmit power by a radio module of the BT device.

In this procedure, referred to as an “Inquiry” (cf. “Bluetooth Specification”, Version 1B, Part B 10.7.1), the BT device, in accordance with the Bluetooth Standard records a unique (Bluetooth) address issued to all BT devices (cf. “Bluetooth Specification”, Version 1B, Part B 13.1) of those BT devices that are located in the transmission area.

After the “inquiry” procedure is concluded the Bluetooth addresses determined can be used to explicitly establish a radio connection to one of the BT devices determined. This procedure is known according to the Bluetooth Standard as the “Paging” procedure (cf. “Bluetooth Specification”, Version 1B, Part B 9.5), in which case a procedure called “Power Control” in the Bluetooth Standard (cf. “Bluetooth Specification”, Version 1B, Part C 13.8) is used with an existing radio connection for adjustment, i.e. to set a new transmit power value, if a communication partner involved in a radio connection sends a message that signals a change in quality.

The disadvantage of such radio telecommunications systems is that a short-range transceiver unit initiating a connection which is transmitting at high power is overridden by receive amplifiers of nearby short-range transceiver units so that it is not possible to establish a connection to the nearby short-range transceiver units.

If the short-range transceiver unit transmits at low power, as per the recommendation of the Bluetooth specification for example, short-range transceiver units that are further away are not reached so that no connection to them can be established.

The problem underlying the invention is to specify a method of establishing a connection to a short-range transceiver unit which increases the rate of successful connection attempts.

This problem is resolved, starting from the method defined in the preamble of patent claim 1, by the features specified in the identification of patent claim 1, as well as, starting from the short-range transceiver unit defined in the preamble of patent claim 10, by the features specified in the identification of patent claim 10.

With the inventive method for establishing a connection in a short-range radio system with at least one first short-range transceiver for which the value of a transmission power is variable, a first transmission power value is initialized. A search is then conducted for a second short-range transceiver in a radio coverage area determined by the first transmission power value, in which case, if a second short-range transceiver is found, information identifying the second short-range transceiver is stored in connection with the first transmission power value. Thereafter a comparison is made between the first transmission power value and a second transmission power value, with the search being ended if equality is established and the search being continued with a modified first transmission power value if the values are not equivalent.

Multiple searches for a second short-range transceiver, with a different transmission power value in each case, guarantee that almost all second short-range transceivers located in a radio coverage area guaranteed by the first short-range transceiver will be identified. In addition storage of information identifying one of the second short-range transceivers found in connection with the first transmission power value used for finding the transceiver means that a connection is set up to a specific second short-range transceiver with a transmit power value that guarantees a high probability of successfully establishing a connection.

If the possible values of the transmission power are restricted by a discreet interval termination of the procedure can be predicted. In addition the method can be simply implemented in communications systems which prescribe or allow a restricted range of values for the transmission power.

If on initialization a low value of the interval, especially the lower limit value of the interval, is set as the first transmission power value and a high value of the interval, especially the upper limit value of the interval, is set as a second transmission power value, in which case on inequality the first transmission power value is incremented, the closest second short-range transceivers can be quickly identified by the first short-range transceiver, if for example finding or communicating with the closest short-range transceivers is the preferred choice.

If on initialization a high value of the interval, especially the lower limit value, is used as a first transmission power value and a low value of the interval, especially the upper limit power value of the interval, is used as the second transmission power value, with the first transmission power value being decremented if the values are not equal, the most distant second short-range transceivers can be quickly identified to the first short-range transceiver if for example finding or communicating with the closest short-range transceivers is the preferred option.

By modifying the first transmission power a discrete increment the method can be simply implemented in digital systems.

In short-range radio systems, especially a system that functions in accordance with Bluetooth, good results are achieved for variations of the transmission power value with transmission power levels for which the value lies in a range between 2 dBm and 8 dBm. The same applies to discrete increments thus produced.

The method can be especially easily implemented and thereby implemented at low cost if the short-range radio system functions in accordance with the Bluetooth Standard.

This advantage is also obtained if the search functions in accordance with the “inquiry” method defined in accordance with the Bluetooth Standard and/or the connection set up functions in accordance with the “paging” method defined in accordance with the Bluetooth Standard.

The short-range transceiver in accordance with the invention features means for initializing a first transmission power value as well as means for searching for a second short-range transceiver in a radio coverage area defined by the first transmission power value. In addition it is equipped with means to store information identifying the second short-range transceiver in connection with a first send power value and means for comparing the first transmission power value with a second transmission power value as well as means for modifying the first transmission power value which are designed in such a way that, if the comparison means establishes equality, the search is ended and on inequality the first transmission power value is modified and directed to the means for searching.

The short-range transceiver in accordance with the invention makes possible a repeated search for second short-range transceivers, in which case the means allow the entire radio coverage area that can be covered by the short-range transceiver to be searched in such a way that second short-range transceivers can respond to the search inquiry.

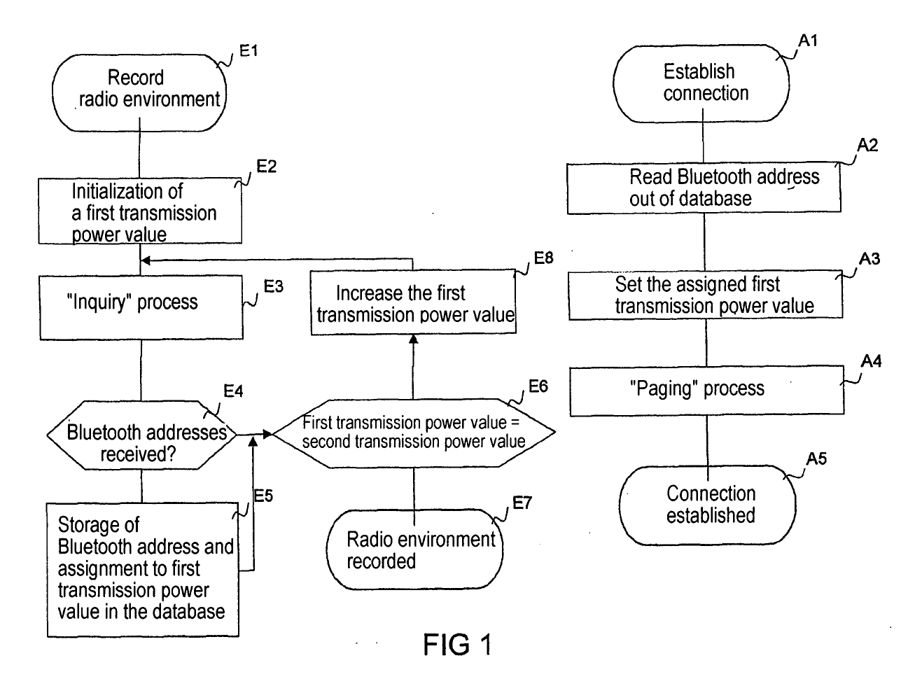

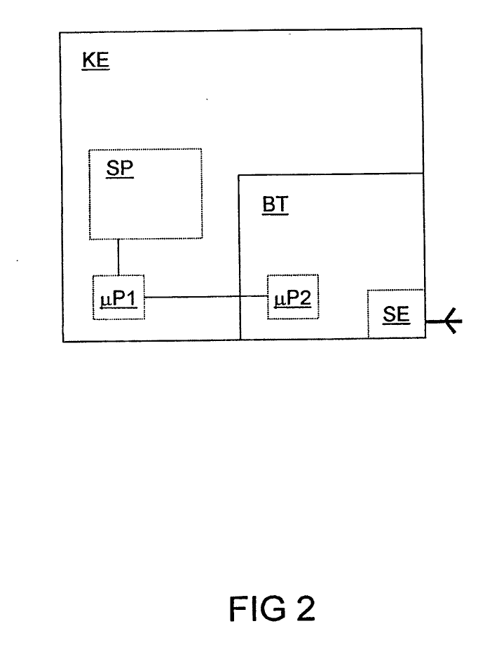

An exemplary embodiment of the invention is explained on the basis of FIG. 1 and FIG. 2. The figures show:

FIG. 1 A flowchart of the method in accordance with the invention

FIG. 2 a short-range transceiver in accordance with the invention

FIG. 1 shows a flowchart of a method in accordance with the invention implemented in a radio communications system designed in accordance with the Bluetooth Standard.

In the exemplary embodiment the method is used in a first short-range transceiver in accordance with the invention according to the Bluetooth Standard, referred to below as Device A, in which case, in accordance with Bluetooth, Device A is a class-1 short-range transceiver (Power Class 1, cf. Bluetooth Specification, Version 1B Part A 3), since for a short-range transceivers of this power class in accordance with the Bluetooth Specification support for what is known as a “Power Control” is specified.

With the “Power Control” feature the transmit output power can be adjusted in stages between a lower limit value (minimum power) Pmin(Pmin<4 dBm) and an upper limit value (maximum power) PmaM.

In this case a specified increment between two consecutive power levels lies in a range of values between 2 dBm and 8 dBm, so that a number of possible discrete power levels from about 4 to 8 is produced. For short-range transceivers in the first power class, such as Device A of the exemplary embodiment, 4 levels are regarded as sufficient to regulate the transmission power, i.e. the setting of a specific power level, which is done under program control, for example by firmware of Device A.

This regulation restricted by the finite number of power levels defines the feature by which Device A has a variable transmission power.

The method in accordance with the invention is identified by the fact that the radio environment is recorded so that the method also begins in a first recording step E1 in a “record radio environment” state.

In this initial state E1 a one-off connection request for example can reach Device A, for example after Device A is switched on, repeated at specific intervals or triggered by an event.

From the first recording step the procedure goes directly to a second recording step E2 in which a Bluetooth radio module of Device A is set for transmitting with a first transmission power value, in which case the first transmission power value is comparable with a variable which is initialized at the beginning of the procedure with an initial value, especially one that can be pre-set or adjusted.

In a third recording step E3 a search of the radio environment is conducted, in which case a radius of a transmission area is produced by the first transmission power value in which at least a second short-range transceiver, referred to as Device B below, can respond to a call made within the framework of the search.

The message of each Device B sent in response to the call made within the framework of the search process undertaken in accordance with the “Inquiry” procedure described at the start contains the Bluetooth address of the relevant Device B, so that in accordance with the invention, a check is made in a fourth recording step as to whether a Bluetooth address has been received.

If it has, in a fifth recording step E5, the Bluetooth address is stored jointly with a reference to the first transmission power value and/or the value itself, in which case, depending on whether the procedure is one-off or event-controlled, storage is temporary until such time as a connection is successfully established or permanent, for example with a structure comparable to a database.

Subsequently in a sixth recording step E6 the current first transmission power value is compared to a second transmission power value which generally represents an upper limit of a range of values (interval) allowed for the transmission power. If the two values essentially match, the procedure is ended and, in a seventh recording step E7, Device A reaches a state “radio environment recorded”.

If the comparison E6 does not produce a match the first transmission power value is increased in an eighth recording step E8, i.e. the variable “first transmission power value” is given a new value and the third through to the sixth recording step E3 . . . E6 are repeated.

In accordance with the invention a multiple repetition of the “inquiry” procedure thus occurs, in which case for the first inquiry. the procedure begins with a low transmission power level recommended in the Bluetooth Specification (between 1 mW and 2.5 mW) and for all following inquiries E3 the power level used is successively increased.

Alternatively power levels can also be left out, i.e. in the eighth recording step E8 two or more discrete (value) steps are added to the current first transmission power value.

The method in accordance with this alternative depends for example on the number of possible power levels in order for example to keep the total duration of the recording steps E1 . . . E8 low.

After the last repetition of the “inquiry” procedure E3 which occurs when the maximum transmission power E6 is reached, even the devices B furthest away have had the opportunity to respond.

The explicit connection setup to a known Bluetooth Device B is performed with a first transmission power value stored in the database.

This is done by starting from a state of “establish connection” in a first setup step A1, reading out in a second set up step A2 the Bluetooth address of the desired Device B as well as the reference to or the first transmission power value and in a third set up step setting the Bluetooth radio module of Device A to transmit with the first transmission power value determined.

Subsequently in a fourth setup step A4, the “paging” procedure described at the start is used with the known Bluetooth address to directly set up the connection so that Device A, if the connection is successfully set up, reaches a state of “connection established” in a fifth setup step A5.

Starting from this state there is then further message traffic with the first transmission power value set.

Only after commands are received to increase or reduce the transmission power in accordance with “Power Control” will another first transmission power value be set within the framework of “Power Control”.

The method described thus makes it possible to establish a connection to Bluetooth devices of all power classes in the transmission area of Device A.

FIG. 2 shows the short-range transceiver KE in accordance with the invention designed as per the Bluetooth Standard.

The short-range transceiver can be a mobile unit, “Personal Digital Assistant” PDA, laptop or comparable mobile terminal which is designed to realize radio connections in accordance with the Bluetooth Standard with a Bluetooth radio module BT and, in addition to the radio module BT also features components such as a first microprocessor μP1 as well as a memory device SP.

The Bluetooth radio module BT shown features items such as a second microprocessor μP2 as well as a radio transceiver unit SE.

To initiate the method in accordance with the invention the first microprocessor μpP1 communicates with the second microprocessor μpP2, so that the first microprocessor μP1 with the radio module BT and the second microprocessor μP2 can represent a possible implementation of the means for initialization.

Means for searching for a second short-range transceiver are realized by the radio module BT, especially by the radio transceiver unit SE controlled by the second microprocessor μP2, whereas the means for storage are provided by the memory device SP of the short-range transceiver KE.

The means for comparing two transmission power values are integrated into the first microprocessor whereas the means for modifying the value are realized by interoperation of the first microprocessor μP1 with the second microprocessor μP2.

Alternatively it is possible for the Bluetooth radio module to execute the method entirely autonomously and thus use its own memory devices as well as exclusively the second microprocessor μP2 to execute the method in accordance with the invention (μP1).

However the invention should not be restricted to the exemplary embodiment shown here but rather should be used for implementing possible further developments of necessary supplementary or alternative devices, especially for executing the further developments and alternatives of the method in accordance with the invention described in FIG. 1, as well as including possible modifications within the framework of expert capabilities.

1. Method for establishing a connection in a short-range radio system with at least one first short-range transceiver unit for which the value of a transmission power is variable, identified by the following steps:
a) Initialization of a first transmission power value (E1, E2),
b) Searching for a second short-range transceiver in a radio coverage area (E3) determined by the first transmission power value,
c) Storage of information identifying the second short-range transceiver in connection with the first transmission power value (E4, E5),
d) Comparing the first transmission power value with a second transmission power value (E6),
e) If they are equivalent, ending the search (E7),
f) If they are not equivalent, repeating steps b) through d) with a modified first transmission power value (E8).

2. Method in accordance with claim 1, characterized in that the values of the transmission power come from a self-contained range of values.

3. Method in accordance with claim 2, characterized in that,
a) with initialization, a low value of the interval, especially the lower limit of the interval, is set as the first transmission power value (E2),
b) a higher value of the interval, especially the upper limit value of the interval, is set as the second transmission power value (E6),
c) on inequality the first transmission power value is incremented (E8).

4. Method in accordance with claim 2, characterized in that,
a) with initialization, a high value of the interval, especially the lower limit of the interval, is set as the first transmission power value (E2),
b) a low value of the interval, especially the upper limit value of the interval is set as the second transmission power value (E6),
c) on inequality the first transmission power value is decremented (E8).

5. Method in accordance with one of the previous claims, characterized in that, the first transmission power is modified using a discrete increment (E8).

6. Method in accordance with one of the previous claims, characterized in that, the discrete increment is determined by a transmission power level for which the value lies within a range of 2 dBm to 8 dBm.

7. Method in accordance with one of the previous claims, characterized in that, the short-range radio system functions in accordance with the Bluetooth Standard

8. Method in accordance with claim 7, characterized in that the search (E3) functions in accordance with the “Inquiry” procedure defined in the Bluetooth Standard

9. Method in accordance with one of the claims 7 or 8, characterized in that
a) a connection setup (A1 . . . A5) functions in accordance with the “paging” procedure defined in the Bluetooth Standard (A4), in which case
b) a Bluetooth address defined as per the Bluetooth Standard is read out from a memory as the information identifying the second short-range transceiver (A2) and also
c) the associated first transmission power value is determined and set before the beginning of the “paging” procedure (A3).

10. Short-range transceiver (KE), identified by
a) Means (μP1, BT, μP2) for initializing a first transmission power value,
b) Means (BT, μP2, SE) for searching for a second short-range transceiver in a radio coverage area determined by the first transmission power value,
c) Means (SP) for storing information to identify the second short-range transceiver in connection with the first transmission power value,
d) Means for comparing (μP1) the first transmission power value with a second transmission power value,
e) Means (μP1, BT, μP2) for modifying the first transmission power value which is designed in such a way that when equality is established by the comparison means (μP1) the search is ended, and if inequality is established the first transmission power value is modified and directed to the means (BT, μP2, SE) for searching.
